(19) United States
(12) Patent Application Publication
(10) Pub. No.: US 2002/0104021 A1
(43) Pub. Date: Aug. 1, 2002

(54) Resource sharing across security boundaries

(76) Inventor: Curtis T. Gross, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 09/774,844

(22) Filed: Jan. 31, 2001

(51) Int. Cl. H04L 9/00

(52) U.S. Cl. 713/201

(57) ABSTRACT

The present invention relates to a system and method for sharing resources between workstations separated by security measures such as firewalls by employing electronic mail messaging and attachments thereto to transmit tasks and/or functions through firewalls for execution at a destination workstation. A dedicated lightweight SMTP server is preferably deployed at destination workstations to operate on incoming email messages associated with tasks for execution at such workstations.

### TECHNICAL FIELD

The present invention relates in general to communication over computer network<s and in particular to sharing resources among computing sites separated by security mechanisms.

### BACKGROUND

It is generally desirable in the field of network communications to transmit various types of data including text and numeric data, instructions, and shared information or documents of various kinds between entities located at varying distances from one another over communication networks. However, obstacles to seamless communication are commonly inserted in between protected private networks, such as corporate LANs (local area networks), and larger networks, such as for instance, the Internet. A “firewall” is one such obstacle and is commonly deployed at junctions between networks in order to provide security against computer viruses and deliberate sabotage.

FIG. 1 depicts communication of an email message through a firewall 104 according to a prior art solution. At an originating site, a task intended for execution at a destination site 101 is attached to an email (electronic mail) message 102 and transmitted along an email gateway 103 over a public network which may be the Internet. Upon reaching destination node on the Internet or other large network, the message encounters firewall 104. Generally, the email is able to pass through firewall 104 via the SMTP (simple mail transfer protocol) port on firewall 104. Thereafter, the transmitted message proceeds to destination email gateway 105. The email message is then generally further transmitted 106 to an SMTP server 107 for ultimate retrieval by a user. Once the message is stored on SMTP server 107, the user to whom the message is addressed may retrieve the message and isolate or separate the task from the email message 108. Thereafter, the user may initiate execution of the task 109.

The use of SMTP generally presents the advantage of allowing substantially unrestricted free flow of electronic mail through protective security measures such as firewall 104. However, the nature of electronic mail communication generally imposes substantial limitations on the degree of shared functionality between different nodes connected over a large network such as the Internet. Specifically, electronic mail generally requires external intervention by a user in order to perform certain tasks associated with an email message, such as, for instance, printing a attached document, running a diagnostic program, or generating an entry in a calendar or other program.

A high degree of functionality and connectivity may generally be shared among various workstations connected to a local area network or other controlled-access network. It is desirable to make such connectivity available over a large public network such as the Internet. However, security concerns generally operate to discourage making such a level of connectivity available where unauthorized persons might access a private network and cause disruption thereof. The use of electronic mail (email) over large public networks such as the Internet or other types of uncontrolled-access networks enables a subset of the connectivity discussed above in connection with LANs to be provided over larger networks, but the use of email is subject to the above-described restrictions.

Certain email programs, such as, for instance Microsoft Outlook®, may conduct a limited number of automated tasks on an incoming email message based on characteristics of the message. Tasks provided in such programs for incoming email messages may include providing automatic replies and filtering incoming messages. The characteristics of a message which may be used to select candidates for operation of the listed tasks generally include contents of the message subject line, keywords present in the message, and the author of the message. Moreover, listservers are generally able to add or remove a user from a mailing list based upon a received message having a particular term in the subject heading of such received message.

Accordingly, it is a problem in the art that the sharing of resources to the extent available in controlled-access networks is generally not available between computing sites separated by security measures such as firewalls.

It is a further problem in the art that communication through firewalls is generally limited to electronic mail communication.

It is a still further problem in the art that executing a task associated with an e-mail message generally requires manual intervention by a user to whose address the email message was sent in order to execute such an associated task.

### SUMMARY OF THE INVENTION

The present invention is directed to a system and method which enables transmission of files from an originating site for automatic execution at a destination site which are able to pass through security measures, such as firewalls, by associating executable files with email messages and transmitting such email messages to workstations in communication with dedicated email servers. Preferably, the dedicated servers are able to act upon a task or function embedded within, or attached to, an email message without manual user intervention by employing functionality deployed within dedicated server software.

In a preferred embodiment, an email server with enhanced features is deployed in communication with workstations to enable automatic execution of tasks associated with email messages. Whereas prior art email server software is generally limited to directing email messages based upon destination addresses, the server software of the present invention preferably includes the ability to detect, extract, and run executable files (or take appropriate actions on other file types such as documents) attached to email messages received by workstations equipped with the inventive server software. In this manner, the inventive server software may be employed to automatically execute tasks which previously would have required user intervention. The inventive arrangement thereby preferably enables a higher level of resource sharing or interaction between workstations separated by firewalls or other security measures.

In a preferred embodiment, SMTP protocol is employed to enable a message, which may be an email message, to penetrate a security measure, which may be a firewall. However, other protocols operable to allow messages to penetrate security measures, such as firewalls, may be employed, and all such variations are included within the scope of the present invention.

The above arrangement generally operates to bypass both the communication restrictions and security features of security procedures such as firewalls. While bypassing the communication restrictions of a firewall is desirable for the convenience provided by being able to direct activity at one site from a remotely located site, bypassing the security features of a firewall may leave a controlled-access network, such as a corporate LAN, open to viruses or to deliberate sabotage by hackers. Accordingly, the present invention preferably includes a mechanism for verifing the identity of a workstation and/or user initiating a request for execution of a function or task at a destination workstation and/or a mechanism for encrypting the contents of an executable file to guard against both unauthorized access to the operation of a destination device and execution of a function by an incorrect destination device.

Accordingly, it is an advantage of a preferred embodiment of the present invention that executable files attached to email messages may be executed without human intervention.

It is a further advantage of a preferred embodiment of the present invention that workstations connected to a common network but separated by firewalls are able to more extensively share resources than could the systems of the prior art could.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWING

For a more complete understanding of the present invention, reference is now made to the following descriptions taken in conjunction with the accompanying drawing, in which:

FIG. 1 depicts communication of an email message over a firewall according to a prior art solution;

FIG. 2 depicts transmission of an email message from a originating workstation for action at a destination workstation according to a preferred embodiment of the present invention;

FIG. 3 depicts a firewall adaptable for protection of a controlled-access network;

FIG. 4 depicts a conventional arrangement of workstations in communication with a mail server;

FIG. 5 depicts a workstation having a dedicated mail server according to a preferred embodiment of the present invention; and

FIG. 6 depicts computer apparatus adaptable for use with a preferred embodiment of the present invention.

### DETAILED DESCRIPTION

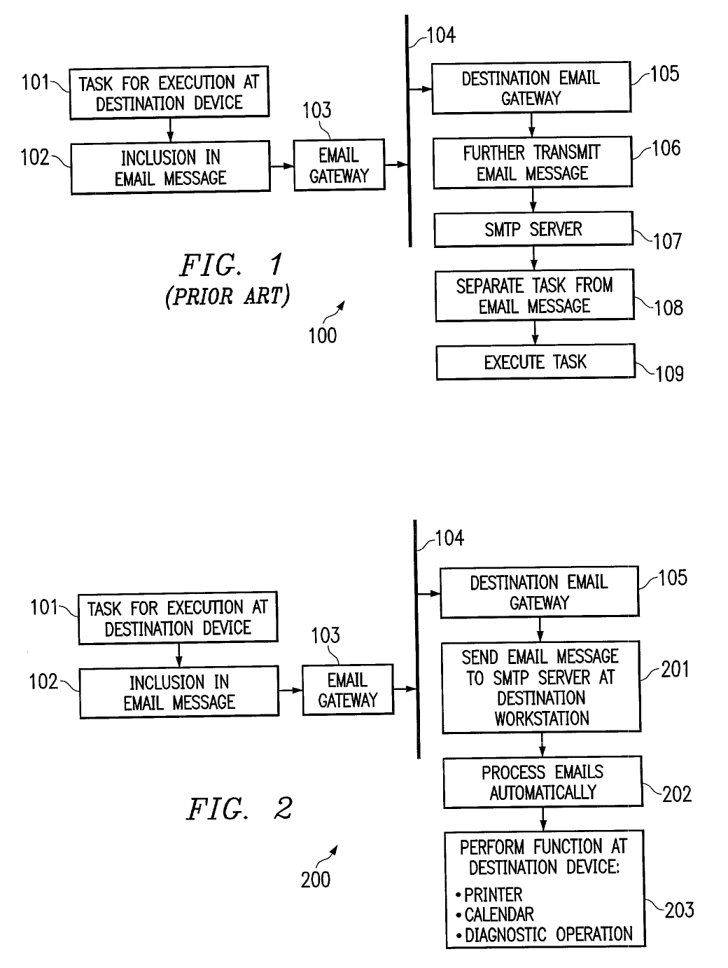

FIG. 2 depicts transmission of an email message from an originating workstation for action at a destination workstation according to a preferred embodiment of the present invention. Elements 101 through 105 of FIG. 2 generally correspond to the like numbered elements of FIG. 1. Specifically, in the embodiment of FIG. 2, a task for execution at a destination device 101 is included in an email message 102 and proceeds through various previously described steps until its arrival at destination email gateway 105.

In a preferred embodiment, the email message is then transmitted 201 to an SMTP server at a destination workstation. The SMTP server concerned in step 201 is preferably dedicated to a particular workstation, thereby enabling email messages to be directed to a specified machine or workstation, rather than merely stored at a server for possible recovery by any one of a number of workstations. A dedicated SMTP server need not be in close physical proximity to the workstation to which it is dedicated, but is preferably operationally coupled therewith. An SMTP server interacting with a workstation in the manner described herein is preferably provided with an ability to demonstrate appropriate authorization to access a particular workstation and to perform a requested action. Preferably, the workstation to which an email having an associated task is directed is coupled to the devices and/or programs able to execute the associated task. For example, where the task embedded or associated with the email in question includes a document to be printed, the SMTP server receiving such an email is preferably dedicated to a workstation which is coupled to a printer suitable for printing the attached document.

In a preferred embodiment, server software deployed on the dedicated SMTP server is provided with the ability to process email automatically 202. Specifically, the dedicated server is preferably able to examine email messages directed to the workstation associated with a dedicated server, determine whether a task or function is associated with an email message, identify the associated task or function if present, and initiate execution of the task or function employing the device, utility, or program suited to the associated task or function without requiring intervention by a user.

For example, where the associated or embedded task or function is to print a document, the dedicated server preferably transmits the document included in the received email message along with appropriate commands to a printer coupled to the workstation having an SMTP server and directs the printer to complete the requested printing task 203. Similarly, where the task is to run a diagnostics program, the dedicated server in receipt of an email associated with this task preferably transmits information pertinent to the task and appropriate commands to a workstation or other computing device able to run the transmitted diagnostics program.

In a preferred embodiment, scripts may be included in the email message having an included task or function in order to appropriately instruct a destination workstation what operations to perform in response to an incoming email message. The contents of such scripts will generally vary depending on several factors including but not limited to: the type of task included in the email message, the nature of the device and/or program intended to execute the task, and the nature, if any, of any encryption employed in encoding the email message. The desired scripts may be generated employing common scripting languages or employing a scripting language developed for a particular application.

In a preferred embodiment, scripts recognizable to commonly used software routines may be employed in order to enable specific tasks to be precisely identified with a minimum of identifying terms. One example of this practice is the use of “primary verbs” within Microsoft Networks®. Employing this program, any file name ending with a “.doc” extension is preferably recognized as a document for which a common operation is printing. For example, where it is desired to print a document, employing the scripting term “print” would cause the receiving workstation to open a document, print it, and then close the document, all in response to the single term “print.” In this manner, the inventive system may economize on the number of commands to be communicated to the destination device without omitting any specificity in describing the actions to be taken upon receipt on an email message. It will be appreciated that the document to be printed could either be transmitted as an attachment to a transmitted email and/or be resident within a network accessible to a workstation receiving the “print” command.

In a preferred embodiment, an email composer tool is deployed to compose email messages including various features enabling email message attachments to be acted upon at a destination workstation without the need for human intervention. The inventive email composition tool (or email composer tool) is preferably able to attach files and associated commands to an email message sufficient to describe a desired operation to a destination workstation. These associated commands are preferably incorporated into an outgoing email message employing scripts so as to enable efficient and accurate communication of desired processing commands to a destination workstation. The email composer tool is preferably further able to incorporate security features such as credential information to enable verification of the identify of a workstation which is the originator of an email message and a requestor of execution of at least one task for execution at a destination device. In addition, the email composer tool is preferably able to encrypt data and command scripts and include digital signatures for identity verification purposes in advance of transmission over a publicly accessible network.

In a preferred embodiment, various security measures may be deployed to prevent unauthorized access to resources deployed within a secure controlled-access network and to authenticate the identity of a party (person and/or device) requesting that a destination workstation execute a set of specified commands. One available security measure is the provision of encryption and decryption tools for preventing unauthorized access to information included in an email transmission. One common approach is the use of public key encryption in combination with private key decryption. Alternatively, encryption may be practiced employing private keys for both encryption and decryption.

In a preferred embodiment, digital signatures may be employed to verify or authenticate the identity of a workstation transmitting a message. Generally, private key encryption is employed to generate a digital signature and public key decryption employed to authenticate the signature. Alternatively however, private key encryption may be employed for both creation of and decryption of a digital signature.

In a preferred embodiment, use of the above security measures would prevent unauthorized control of operations within a controlled-access network. Although a hacker could theoretically transmit an email message to a server dedicated to a workstation within a controlled-access network, such a hacker would not have access to the key or keys with which to produce a uniquely identifying digital signature or to encrypt the data and instructions transmitted. In this manner, the inventive mechanism may prevent unauthorized and potentially destructive access to resources disposed within a controlled-access network.

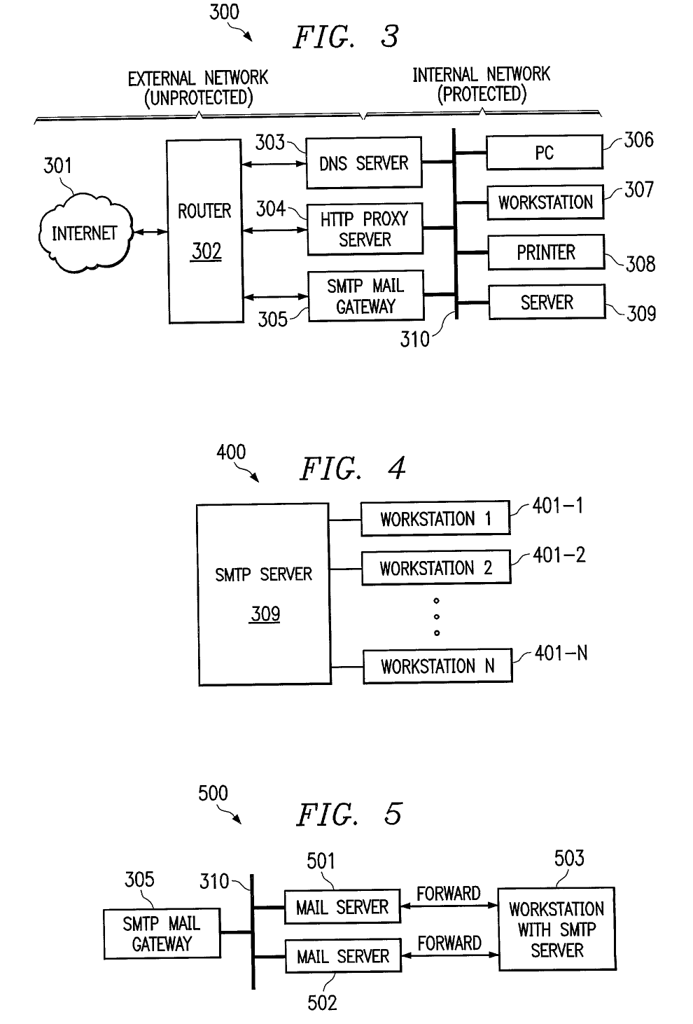

FIG. 3 depicts a firewall adaptable for protection of a controlled-access network. The linked networks 300 depicted in FIG. 3 include the Internet 301 which is coupled to a controlled-access network 310 via router 302. Router 302 of FIG. 3 is generally included in firewall 104 represented in FIGS. 1 and 2. Preferably, DNS (Domain Name Server) server 303 HTTP server 304 and SMTP (simple mail transfer protocol) server 305 operate to allow communication between Internet 301 and controlled-access network backbone 310. DNS server 303 and HTTP server 304 generally allow limited forms of communication between controlled-access network backbone 310 and Internet 301.

Accordingly, the extent of resource sharing generally available among workstations connected to a common controlled-access LAN would generally not be available between Internet 301 and controlled-access network 310 in the embodiment of FIG. 3. SMTP server 305 preferably allows messages to flow in both directions between Internet 301 and controlled-access network backbone 310. However, manual user intervention is generally required in order to allow tasks or functions which may be attached to email messages incoming to controlled-access network backbone 310 to be executed by a workstation, such as workstation 307, connected to controlled-access network backbone 310. Accordingly, tasks or functions communicated to destination workstation 307 by a workstation connected to controlled-access network 301 via Internet 301 would generally require manual user intervention, thereby preventing the efficiency and convenience of having such tasks or functions executed automatically.

FIG. 4 depicts a conventional arrangement of workstations 401-1 through 401-N in communication with SMTP server 309. Generally one server, such as server 309, is able to operate email accounts and store email messages associated with a plurality of different accounts. Moreover, email account information stored on SMTP server 309 may generally be accessed employing any one of a plurality of workstations, such as workstations 401-. 1 through 401 -N. Accordingly, such an arrangement is generally not amenable to receiving an email message directing that a function or task be executed by a particular workstation.

FIG. 5 depicts a workstation 503 having a dedicated mail server according to a preferred embodiment of the present invention. As was the case in the embodiment of FIG. 3, SMTP mail gateway 305 preferably conducts bidirectional email communication with controlled-access network backbone 310. Mail servers 501 and 502 preferably both operate to forward email messages between controlled-access network backbone 310 and workstation 503. Mail servers 501 and 502 are generally equivalent to mail server 309 depicted in FIG. 3.

In a preferred embodiment, workstation 503 includes a dedicated SMTP server. SMTP server software could be deployed either within workstation 503 or in a device coupled to workstation 503. In either case, workstation 503 is preferably provided with a unique email address and the ability to receive and open email directed thereto. In addition, the server software disposed either within or in communication with workstation 503 preferably includes the ability to run executable files attached to email messages (or take appropriate actions on other file types such as documents) arriving at workstation 503 without a need for human intervention, i.e. automatically. This capability is preferably enabled by the provision of an email address specific to the particular workstation and functionality deployed within the dedicated server software for receiving email messages, opening these messages, isolating files attached to incoming email messages, and, where appropriate, running executable files received as attachments to email messages incoming to workstation 503.

In a preferred embodiment, functions or tasks which may be included in such executable files or which may be resident within the SMTP server dedicated to workstation 503 and executable in response to an email including an appropriate identification of such functions or tasks include but are not limited to: printing documents, running diagnostic programs, generating calendar entries, retrieving calendar entries of one or more users having accounts accessible from workstation 503, conducting database searches, and modifying word processing and other documents.

In a preferred embodiment, dedicated server software deployed in a recipient workstation may fully respond to commands including one or more parameters for completion of a command. For example, in addition to specifying that a document is to be printed, a command may specify other parameters such as, for instance, a printer on which to print the document, and the format (such as portrait or landscape) in which to print the document.

In a preferred embodiment, in response to an email received at workstation 503 including a command to print or otherwise act upon a document, the inventive mechanism may be employed to act upon either a document attached to the received email, upon a document already resident on a network accessible to workstation 503, or upon a combination of the foregoing. Likewise, where an email received at workstation 503 includes a command which designates an operation or application to be performed by workstation 503 or a device in communication therewith, the executable code associated with the included command may be included as an attachment to the received email message, already be resident on workstation 503 or at a device in communication with workstation 503, or a combination of the foregoing, and all such variations are included in the scope of the present invention.

Thus, in contrast to the workstations 401-1 through 401-N of FIG. 4, when using workstation 503, the opening of incoming email messages and files attached thereto and the execution of files attached to email messages may be accomplished automatically. It will be appreciated that the SMTP server software dedicated to workstation 503 need not be deployed within the hardware which forms workstation 503 or even in a device directly connected to workstation 503. The dedicated SMTP server software need only be deployed so as to ensure accessibility of the server software over controlled-access network backbone 310 to workstation 503. It will further be appreciated that workstation 503 is not limited to any particular hardware configuration or operating system. Workstation 503 may be any one of a group which includes but is not limited to: a personal computer running Microsoft Windows, a UNIX machine, and a LINUX machine.

In a preferred embodiment, the SMTP server software dedicated to serving workstation 503 includes the ability to act upon a task identified by an email message, whether within the body of such email message or within an attachment to such message, check the authorization of the requesting entity (possibly a workstation) to have this task performed, verify the identity of the requesting party, and determine the authority of an identified requesting party to request execution of a particular function. The identity of a requesting party may be verified by numerous means, such as, for instance, by decrypting a digital signature originally encrypted by the requesting party.

In a preferred embodiment, workstation 503 may be coupled to one or more of a plurality of devices for executing tasks identified by an email message, such as, for instance, a printer and a computer for running diagnostic programs and/or updating a calendar based upon information included or attached to the email message.

In the prior art, there are generally a restricted group of functions or actions which may be automatically (i.e. without human intervention) performed on an email message received at a workstation, as a consequence of the usual operation of the SMTP protocol. Such activities generally include automatically replying to received email messages as well filtering and/or sorting messages based upon characteristics of the received message. Herein, the term “restricted operations” generally corresponds to this group of functions, which functions are generally limited to manipulation of email communication and the handling and/or storage of received messages.

In contrast, the present invention presents a more extensive group of functions which may be performed in response to received email messages which functions extend considerably beyond the mere manipulation of email communication (such as automatic replies) and storage and sorting of email messages. This more extensive group of functions generally includes the ability to perform operations consistent with the extent of resource sharing commonly provided between workstations (and/or between workstation and a service component such as a printer) coupled to the same private network. This more extensive group of operations generally includes operations such as printing a document included within, or attached to, an email message, and executing a routine which may be in a file attached to an email message, included within the body of an email message, or merely identified by data within an email message, but resident within a network to which a recipient workstation is connected. Herein, the terms “extensive operations” and “group of extensive operations” generally correspond to the functions described in this paragraph.

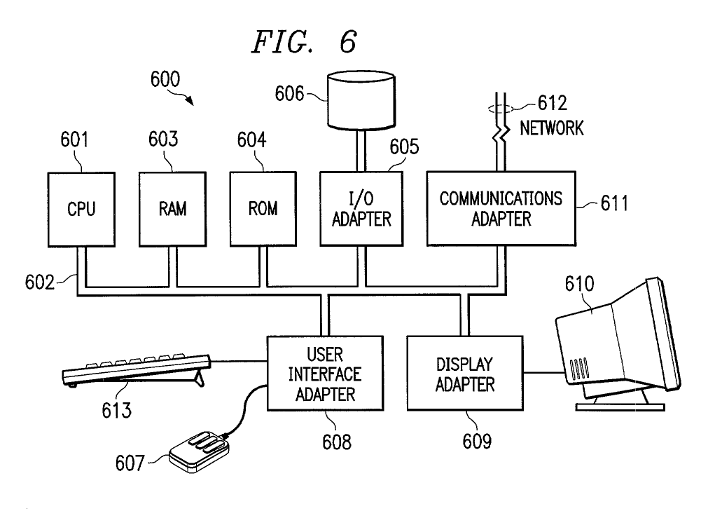

FIG. 6 illustrates computer system 600 adapted to use the present invention. Central processing unit (CPU) 601 is coupled to system bus 602. The CPU 601 may be any general purpose CPU, such as an HP PA -8200. However, the present invention is not restricted by the architecture of CPU 601 as long as CPU 601 supports the inventive operations as described herein. Bus 602 is coupled to random access memory (RAM) 603, which may be SRAM, DRAM, or SDRAM. ROM 604 is also coupled to bus 602, which may be PROM, EPROM, or EEPROM. RAM 603 and ROM 604 hold user and system data and programs as is well known in the art. The bus 602 is also coupled to input/output (I/O) adapter 605, communications adapter card 611, user interface adapter 608, and display adapter 609. The I/O adapter 605 connects to storage devices 606, such as one or more of hard drive, CD drive, floppy disk drive, tape drive, to the computer system. Communications adapter 611 is adapted to couple the computer system 600 to a network 612, which may be one or more of local are network(LAN), wide-area network (WAN), Ethernet or Internet network. User interface adapter 608 couples user input devices, such as keyboard 613 and pointing device 607, to the computer system 600. The display adapter 609 is driven by CPU 601 to control the display device 610.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for sharing resources between first and second workstations separated by a segment of a public network, the method comprising the steps of:
transmitting a message from said first workstation to said second workstation separated from said first workstation by at least one security measure and disposed within a destination computing site;
employing a protocol to enable said transmitted message to penetrate said at least one security measure; and
executing a command included in said transmitted email message.

2. The method of claim 1 wherein said message is an email message and said protocol is SMTP (Simple Mail Transfer Protocol)

3. The method of claim 1 wherein said step of executing said command comprises the step of:
enabling an SMTP server dedicated to said second workstation to automatically perform at least one operation selected from a group of extensive operations.

4. The method of claim 1 wherein said executing step comprises the step of:
performing an operation on data other than said transmitted message.

5. The method of claim 1 further comprising the step of:
at said second workstation, verifying an identity of said first workstation.

6. The method of claim 1 wherein said at least one security measure is a firewall.

7. The method of claim 6 further comprising the step of:
disposing said destination computing site within a controlled-access network.

8. The method of claim 7 further comprising the step of:
disposing said firewall in between said public network and said controlled-access network.

9. The method of claim 7 further comprising the step of:
attaching an executable file to said message, wherein said executing step comprises the step of:
executing said attached executable file.

10. The method of claim 1 wherein said executing step comprises the step of:
executing a routine resident in said controlled-access network identified in said message.

11. The method of claim 10 wherein said step of executing comprises the step of:
running a diagnostic program at said second workstation.

12. The method of claim 1 further comprising the step of:
identifying said included command employing at least one script recognizable to said second workstation

13. The method of claim 1 wherein said executing step comprises the step of:
performing an operation on a document attached to said transmitted email message.

14. The method of claim 1 wherein said executing step comprises the step of:
performing an operation on a document resident within said destination computing site.

15. A system for securely enabling resource sharing among a plurality of workstations over a public network, the system comprising:
means for transmitting a message from a first workstation of said plurality of workstations onto said public network;
means for enabling said transmitted email message to pass through a firewall separating said public network from a workstation disposed in communication with a controlled-access network coupled to said public network;
means for receiving said transmitted email message at said second workstation;
means for verifying an authorization of said first workstation to request execution of a selected function at said second workstation; and
means for automatically performing said selected function at said second workstation if said authorization of said first workstation is verified.

16. The system of claim 15 wherein said message is an email message.

17. The system of claim 15 wherein said means for enabling comprises:
an SMTP port for enabling communication of said message through said firewall.

18. The system of claim 15 further comprising:
an email server dedicated to said second workstation; and
means for enabling communication between said dedicated email server and said second workstation.

19. The system of claim 15 wherein said means for verifying said authorization comprises:
means for generating a digital signature at said first workstation; and
means for decrypting said digital signature at said second workstation.

20. The system of claim 15 wherein said means for automatically performing comprises:
means for running an executable file attached to said message.

21. The system of claim 15 wherein said means for automatically performing comprises:
means for running an executable file identified in said message and resident in said controlled-access network.

22. The system of claim 15 wherein said means for automatically performing comprises:
means for performing an operation on a document attached to said message.

23. A system for causing a function to be performed at a destination computing site remote from a requesting computing site, the system comprising:
an email composer disposed in communication with a requesting computing site for composing an email message including a task description and data authenticating said requesting computing site;
a network link for enabling transmission of said composed email message;
a mail gateway disposed in communication with said destination computing site for receiving said transmitted composed email;
a mail server dedicated to a destination computing device disposed within said destination computing site for identifying said task description;
means for verifying said authenticating data; and
means for executing said described task where said authenticating data is verified.

24. The system of claim 23 wherein said authenticating data includes a digital signature.

25. The system of claim 23 wherein said destination computing site is coupled to a local area network.
